(19) United States
(12) Patent Application Publication
(10) Pub. No.: US 2002/0082996 A1
(43) Pub. Date: Jun. 27, 2002

(54) Real time single interface data reporting method

(75) Inventors: Bobby D. Scott, Phoenix, AZ (US); Christopher G. Bowen, Mesa, AZ (US); Ed Villareal, Phoenix, AZ (US); Michael Garrity, Gilbert, AZ (US); Patti Walker, Gilbert, AZ (US)

Correspondence Address: LAVALLE D. PTAK, LAW OFFICE OF LAVELLE PTAK, 28435 N 42ND STREET, SUITE B, CAVE CREEK, AZ, 85331, US

(73) Assignee: Leapsource Inc.

(21) Appl. No.: 09/748,399

(22) Filed: Dec. 26, 2000

(51) Int. Cl. G06F 17/60; H04K 1/00; H04L 9/00

(52) U.S. Cl. 705/51; 705/30

(57) ABSTRACT

A single interface delivery system and method for clients of an outsourcing facility includes control of the processing of input information, the server computers and the link between the server computers and the output at the client by the outsourcing facility. As a result, data obtained by the client on demand at the output is real time or near real time data, because all of the content is controlled by the outsourcing entity. The method includes gathering transaction information from a client and processing that transaction information to create reports desired by that client. In addition, news and other information is gathered by the outsourcing facility based on client-designated requests, and is supplied to the server computer at a client address. Therefore, the client does not have to separately access the various news and information addresses on the worldwide computer network. This information is supplied, along with reports based on the client's business information, for direct and ready access by the client from the system server at the specific address designated for that client.

### BACKGROUND

Companies of all sizes, from relatively small operations to extremely large, multi-national business, increasingly are outsourcing many of their business functions to specialized companies for efficient and economical handling of those functions. Such practices are known as BPO (Business Process Outsourcing) BPO involves the movement of non-core activities, such as maintenance, security, and finance and accounting, for example, to an outside vendor who optimizes processes, deploys technologies and manages people, to allow companies to concentrate on their core competencies. Consequently, BPO of operations, such as finance and accounting, results in significant reductions in staff and time required to accomplished these “back office” operations.

In most companies, select senior executives, typically the CEO, CFO, CIO or COO, require frequent (and in many cases, daily) information concerning the finance and accounting status of their business. In addition, these executives often desire related information concerning various aspects of their business, and that of their competitors. While this related information is not finance and accounting information, it is relevant to an understanding of the business environment in which the company operates, and is used to implement effective business strategies.

Presently, most high level officers of companies of all sizes use the worldwide web, or Internet, for a variety of purposes. Almost all top executives use the Internet to communicate with employees or business partners. In addition, various databases are scanned by executives to review pertinent business or industry news and to obtain accurate data about customers and suppliers. Many CEO's, CFO's, etc. use the Internet to assist them in obtaining better forecasting tools or access to financial data. A nearly overwhelming amount of information is available on various databases on the worldwide computer networks (Internet). New databases are added daily; and although hyperlinks allow movement from one database to another by a user, the necessity to log onto various databases and review the information available on them can be very time consuming. This is true even if files of favorite database addresses and bookmarks are employed by the user.

Some companies already have access to all of the information mentioned above. To gather, that information, however, officers or other personnel desiring to view that information need to make painstaking, time consuming navigation through complex enterprise resource planning (ERP) software, or multiple legacy systems, or wade through cumbersome manual processes, pulling data from different reports and then analyzing it. The time consumed in obtaining this information basically is wasted time. The CEO, CFO or other officer, or their assistants, can find far better uses for their valuable time than that which is spent on gathering data in such a conventional manner. This is true whether a BPO provider is used or other data, such as finance and accounting, is processed internally.

In addition to being able to obtain key business performance data and other related information by way of Internet connections on a personal or laptop computer, many businessmen desire to have that information available anywhere in the world, at any time. Not only is it desirable to obtain the information anywhere, at any time, but it is desirable to obtain that information without a time consuming interconnection process and search, whether the information is being requested at the office or at a remote location in some other part of the world.

Accordingly, it is desirable to provide an interface system and method for business executives which provides them key current information about their companies and other desired related information in a simple real time or near real time manner.

### SUMMARY OF THE INVENTION

It is an object of this invention to provide business executives with the ability to take an active role in processing transactions at any time, in any place.

It is another object of this invention to provide client transaction information and designated non-client information on a real time or near real time basis.

It is an additional object of this invention to provide secure real time access to a client's business information and client designated related information.

It is a further object of this invention to provide easy to use real time data reporting of designated client transactions and client designated data to client selected retrieval devices.

In accordance with a preferred embodiment of the invention, custom tailored information for a client, including but not limited to data based on client generated information, is accomplished by first gathering transaction information from a client. The transaction information then is processed to create reports based on that information. In addition, client designated news information or other data is obtained from available news sources, such as various Internet databases. The reports based on the transaction information and the client designated news or other information is supplied or delivered through to a system server for storage at a specified address for the client. The client then is allowed access to the information at the specified address.

### BRIEF DESCRIPTION OF THE DRAWINGS

FIG. 1 is a flow chart illustrating the operation of a preferred embodiment of the invention;

FIG. 2 is a flow chart illustrating the manner of handling change requests in the embodiment of FIG. 1;

FIG. 3 is a flow chart further illustrating the handling of change requests; and

FIG. 4 is a flow chart illustrating a feature of the preferred embodiment of the invention.

### DETAILED DESCRIPTION

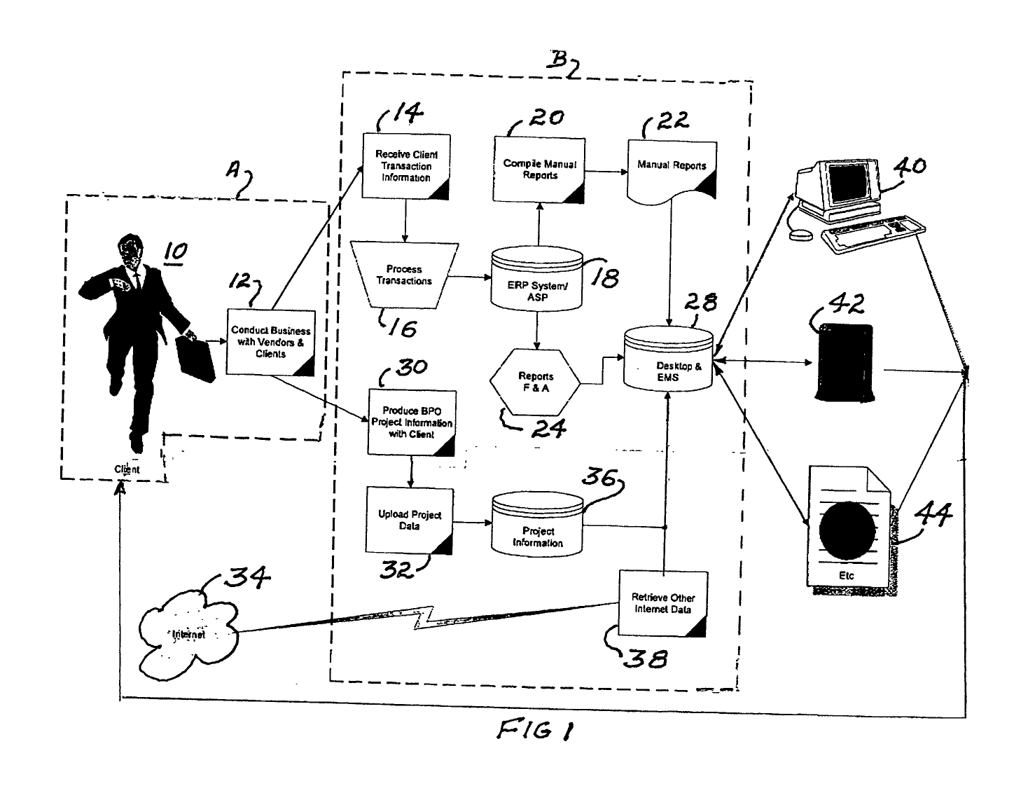

Reference now should be made to the drawings, in which the same reference numbers are used in the different figures to designate the same method and system components. FIG. 1 is a flow chart showing applicant's preferred embodiment.

In FIG. 1 a client is designated at 10. This client 10 typically is a middle or large sized business supplying transaction information to a BPO provider, the system and function of which is enclosed within the dotted line portion “B” of FIG. 1. Typically, the BPO provider “B” provides finance, accounting, work flow analysis, imaging technology and other services, as desired by the client 10, shown located within the dotted line portion “A” of FIG. 1.

Although the BPO activities may be of a wide variety, typical activities are accounting and financial activities of various types. The client 10 conducts business with vendors and clients, as indicated at 12 in FIG. 1. This business is conducted in a conventional manner; and the BPO provider is provided with a BPO project information plan and other project-related information in conjunction with the client, as shown at 30. This plan defines the nature of the transactions which are to be provided by the BPO provider including, but not limited to, the frequency and type of reports which are to be made.

Once the BPO project information has been determined, it is uploaded by the BPO provider at 32, and supplied to a project information server 36. Although the server 36, along with other servers to be described subsequently, is shown in FIG. 1 as associated with a single client, it is to be understood that the various servers each operate to provide BPO services to many different clients. Each of the servers, including the project information server 36, includes a memory with a specified address for the particular client 10 for which the uploaded project data 32 is provided. Each different client has a unique address in each of the servers shown in FIG. 1; and access to those addresses is available only to the client for which those addresses are designated. This is described in greater detail subsequently.

In conjunction with the BPO project plan or project information, the transactions to be processed by the BPO provider then are supplied from the client at 12 to the BPO provider at 14, which receives the client transaction information. This can be payroll information, receivables, invoices, inventory control, or the like. The project data uploaded at 32 into the project payroll information server 36 can be a result of the transaction information at 14, or can drive the process, depending on how the project team for the system sets it up. Once the client transaction information is received at 14, it is processed by the BPO provider at 16 and supplied to a server 18 for enterprise resource planning (ERP) hosted by an application service provider (ASP), as determined by the BPO provider “B”.

The ERP system/ASP server 18 also has designated memory in it for the transactions of the client 10 for compiling and preparing reports based on those transactions, such as finance and accounting reports at 22, and manual reports at 20, as shown in FIG. 1. After the manual reports are formatted, they may be electronically uploaded to the desktop and enterprise management system (EMS) server 28.

The finance and accounting reports (or other designated reports) at 24 are accessed by the desktop and EMS server 28 for the client 10. As mentioned previously in conjunction of the project information server 36, the ERP system/ASP server 18 and desk top and EMS server 28 have multiple memory addresses in them, each corresponding to different clients, such as the client 10 shown in FIG. 1.

In addition to providing reports and transaction operations defined by the project information and the transaction information supplied by the client at 14 and 30, the system shown in FIG. 1 is designed to retrieve other Internet data at 38 over the Internet or worldwide web 34 from data and information sources available at various domain locations on the Internet 34. The data retrieved at 38 is specifically determined as part of the project data obtained from the client 10, in conjunction with the business project information described previously, to supply periodically updated information, such as financial information, general news, consumer news, weather, regional information, sports information, and so forth. The list of potential items of interest to the client 10 is nearly endless.

Once the client 10, however, designates the information databases and/or subjects which are of interest to it, the EPO provider “B” then periodically, at pre-established intervals, retrieves the designated information material at 38 from the Internet 34. The intervals may be hourly, daily, weekly, monthly or any other interval which is considered to be a critical or sufficient interval to the client 10. Once the intervals of gathering this Internet data, or other data in addition to the client generated information at 12, is determined, however, the updating is effected at those intervals by the BPO provider “B”. This updated other information obtained from the Internet 34 is supplied by the retrieval at 38 to the desk top and EMS server 28, along with the client-specific data obtained at 22 and 24, as described previously. All of this client-specific information is supplied to the client address in specifically identified slots for that address to provide the client 10 instantly available access to the information, at any time.

Since the BPO provider “B” controls all of the links, including the ERP system/ASP server 18, project information server 36, and the EMS server 28, no delays are encountered by the client 10 in accessing the client's designated information at any time the client wants that information. Without control of all of the links, namely client input, processors, and output to the client, delays of the type encountered with conventional prior art systems would be encountered. The result of the system and method described in conjunction with FIG. 1 is that real time, or near real time, information is continuously available to the client 10 as soon as that information is updated and placed in the memory of the server 28 at the specified address for that client.

Whenever the client 10 desires access to its information, that access is obtained from a request initiated through a universal resource locator (URL) and the client's password from a personal computer or laptop computer 40, or a Palm VII® handheld computer, or its equivalent, or by means of any other suitable device 44. The server 28 sits behind a firewall with an internal IP address. Connections between the server 28 and any of the client devices 40, 42 or 44 are over secure socket layers (SSL) with 128-bit encryption. Currently, the server 28, in a preferred embodiment of the invention, is running Microsoft's Internet Information Server (IIS) and utilizes the security model of Windows® NT. The client 10 is able to access its own area (and all the subsections within it, as described previously) based on the permissions granted to the user name and password, which is supplied from the client to the server 28. NT controls the security.

In operation, a client executive at 10 opens the interface in their web browser (any suitable conventional browser) through one of the devices 40,42 or 44. The request of the client 10 then is supplied to the BPO provider's router and firewall (not shown, since these are standard). The client 10 then is prompted to enter its log in and password. Once the server 28 and the client 10 have been authenticated by one another in a conventional manner, the client 10 can access its area at the specified address in the server 28. The firewall only allows hypertext transfer protocol (HTTP) requests to travel between the client computer, such as the computer 40, and the server 28.

It should be noted that the intervals at which the client transaction information is received at 14 and the other Internet data is retrieved at 38 are independent of one another. Typically, the Internet data is retrieved at pre-established time intervals. Similarly, the client transaction information generally is received at pre-established time intervals; but random intervals could be established if that is a part of the BPO project data supplied at 32 to the project information server 36. At any given time, however, the latest information based on the gathering criteria at the Internet retrieval 38, or at the client transaction information 14, is available in its processed form at the desktop and EMS server 28 for instantaneous, or nearly instantaneous, real time access by the client through any of the devices 40, 42 or 44 which are indicated in FIG. 1.

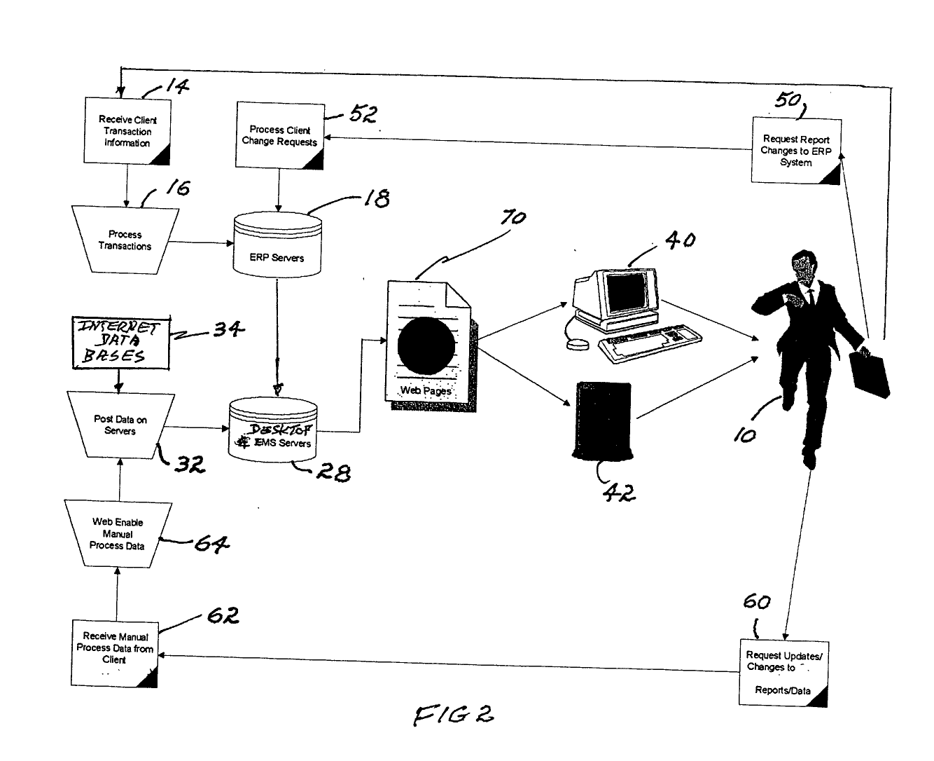

Reference now should be made to FIG. 2 which illustrates the manner in which changes in the BPO provider operation may be requested by the client 10. If changes to the ERP system are desired, these are supplied from the client 10 in the form of a request at 50, which then is processed at 52 by the BPO provider. Once the changes are processed, they are supplied to the ERP server 28 to be incorporated in the ERP software. Then, client transaction information at 14 is processed, as described previously, at 16 and supplied to the ERP server 18, where it is handled in accordance with the change requests described above in conjunction with the request 52 supplied to the server 18.

If changes to the reports and data corresponding to the project information is desired, this is supplied at 60 from the client to the BPO provider, which receives the manual process data from the client at 62. This data is then web enabled at 64, and the data is posted on the servers at 32, from which it is supplied to the desktop and EMS server 28. Similarly, any changes to the Internet databases at 34 are supplied and posted at 32 to the desktop and EMS server 28.

Although not mentioned above in the discussion of FIG. 1, the output of the desktop and EMS server 28 for the memory address of the client 10 is displayed to the client on individual web pages 70 uniquely corresponding to that client. The web pages 70 are customized for the client 10; so that when information access is desired by the client through any of the devices, such as the PC 40 or the Palm VII® 42, that information is displayed on a unique web page, clearly identifiable with the specific client 10. Any time changes to the method and system of FIG. 1 are desired, the changes are effected in accordance with the sequence described in conjunction with FIG. 2.

It is apparent from a consideration of the method shown in FIGS. 1 and 2 that a personal interface between the BPO provider and the client 10 occurs, at least at the point of the production of BPO project information with the client at 30 in FIG. 1, and in conjunction with the process change requests at 52 and 62 of FIG. 2. To effect this on the part of the BPO provider, an account manager for the specific client 10 is provided, along with Knowledge Support Services (KSS) to function at whatever level is required for each particular client 10. The account managers are the first point of contact for the client 10 using the BPO provider method and system described in FIGS. 1 and 2.

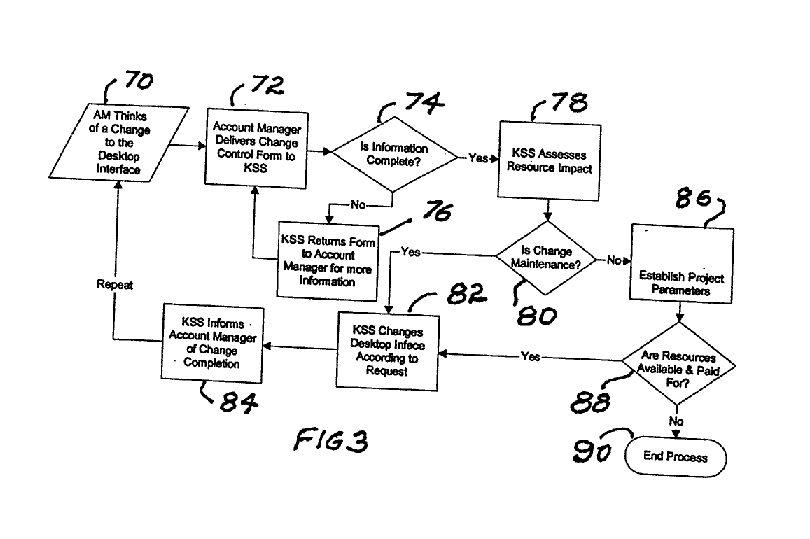

The manner in which changes of the type described in conjunction with FIG. 2 are effected in the system is shown in greater detail in FIG. 3. As indicated in FIG. 3, the account manager (AM) thinks of a change to be implemented in any of the areas in FIG. 2 (and in other areas not specifically shown in FIG. 2) at 70. The changes may be requested by the client or initiated by the AM. The change is supplied by the AM to the KSS at 72, which handles the technical side of the changes within the BPO provider. KSS then determines whether the information is complete at 74. If it is not, KSS at 76 returns the form to the account manager for more information, re-processing that information at 72 once again.

If the information is complete at 74, however, KSS assesses the resource impact of that change at 78. Essentially, this resource impact is to determine whether the change is simply maintenance at 80. If it is maintenance, KSS then changes the interface according to the request at 82 and then informs the account manager of the completed change at 84. The change then has been implemented, as desired, by the client, through the account manager; and data is processed in accordance with that change.

If the change at 80 is not a maintenance change, however, a determination is made to establish the project parameters at 86. If resources are available and paid for as determined at 88, the change is made at 82, as described previously. If the resources are not available and paid for, however, the process ends at 90. Further face to face meetings to determine whether such changes can be implemented then need to be made between the AM and the client.

There may be times when the AM needs to remove a client from the interface of the system. In such a case, the AM simply follows the change control process described above in conjunction with FIG. 3, and the removal is effected. It should be noted that the AM should communicate all changes, particularly concerning changes for removing a client, with KSS as soon as these changes are known. This process helps ensure that the interface is secure from unauthorized users. When dealing with an employee of the client rather than the client as a whole, the burden of responsibility of access to proprietary client information obviously lies with the client.

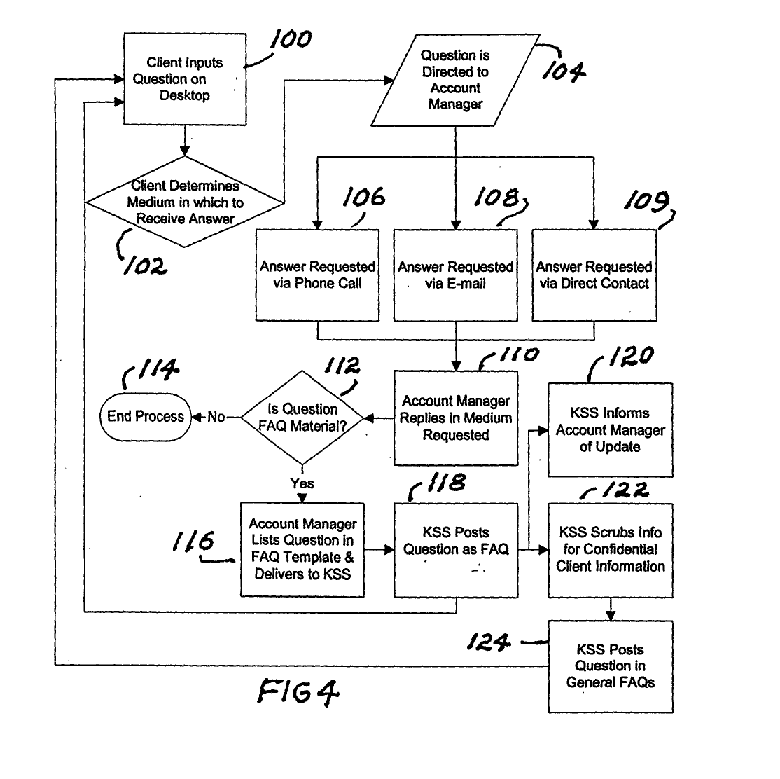

In conjunction with the process and system shown in FIG. 1, the client 10 also is provided with the opportunity to enter questions into his or her interface devices, such as the desktop computer 40, or the Palm VII® 42 and submit those questions electronically through the firewall to the BPO provider. This is in addition to requesting specific data from the server 28, as described above. The manner in which this is done is shown in FIG. 4. The client 10 inputs the question on the desktop computer 40, or other input device, at 100. The client determines the particular medium in which an answer is to be received at 102. The question then is directed to the AM at 104. The answer request is noted by the AM as by phone call at 106, by e-mail at 108, or by direct contact at 109. The choices are available at the interface of the client at 40 or 42 (FIG. 1) through an electronic question input form.

The AM reviews the question in his or her e-mail, and replies in the medium requested at 110. A determination is made by the account manager at 112 as to whether or not the question and answer will be useful to the client in the future. If the answer to that question is no, the process ends at 114. If the answer to the usefulness of the question and answer for future is yes, or if the question would be useful to other clients, the question and answer are entered into a template, identified in FIG. 4 as a frequently asked question (FAQ) template at 116; and this template is delivered to KSS. KSS then posts the question and answer at 118 and informs the client at 100 and the AM of the update at 120. This is for the client who requested the information at 100.

At the same time, if the question and answer are considered useful to other clients, KSS scrubs the information for any confidential client information at 122; so that the identity of the client cannot be determined. Once this has been done, KSS posts the question in a general FAQ at 124. The information also is posted in the client's FAQ section at 100 and the transaction is complete. Generally, for most questions and answers, saving the question and answer for subsequent review or use by the same client or other clients is not done. In that event, the process is completed through steps 112 and 114, as described above.

In the process and system described above in conjunction with FIG. 1, the AM and KSS initially need to assess the format in which key client financial information is to be delivered by the client 10 to the BPO 14 of FIG. 1 for deployment by the BPO provider for the interface to the client access devices 40, 42 and 44. If the client information is web-enabled (HTML/XML), KSS simply provides a link from the client desktop 40 or the Palm VII® 42, or other device 44, to the financial database at the server 28; and little manual interaction is required. If on the other hand the original financial information from the client is not web-enabled, but is in some other format, KSS then works with the AM to process the information through converters to present it in HTML.

The account manager (AM) determines the frequency (in conjunction with the client) with which to update the financial information through the processing of transactions at 16 of Figure 1. If the AM chooses not to upload the reports, he/she then informs KSS in advance of the update schedule (a standard for most financial information is one time per month). Prior to the date for updating, typically five days in advance, the AM provides KSS with the financial updates. KSS then updates the viewable file on the web server for the client 10, and informs the AM of the update by way of e-mail. For a typical system, the updates are posted by 9:00 AM on the first business day when the financial statements are required by the client. The frequency, timing and other parameters of the updating of this information are variable and are determined in accordance with the project information provided to the AM initially at 30, in the method and system shown in FIG. 1.

For key performance indicators (KPIs), the account manager and KSS again will assess the format in which the KPIs of the client are to be delivered for deployment on the desktop interface to the interface devices 40, 42, 44 of the client. The process which is used for KPIs is identical to that described immediately above for the key financial information. It is handled in the same way; and updates are provided in accordance with a pre-established schedule between the client and the AM.

The foregoing process and system for a real time single interface data reporting method provides maximum flexibility for executives of the client. Particularly through use of the Palm VII® 42, an executive, through secure encrypted password-accessed links to the company's data in the desktop and EMS server 28, can obtain the desired information at any time and at any Internet accessible place in the world where 128-bit Secure Socket Layer (SSL) encryption is available. The method and system which have been described are particularly valuable in conjunction with the handling of finance and accounting transactions for clients, among other processes. The BPO process operates through secure dedicated connections to gather information from a client's operations all over the world, or from many locations to one location. The information then is processed and distributed back to decision makers of the client organization through the desktop and EMS server 28. Client generated information, as well as information retrieved from other Internet databases, as designated by the client, all is available at the pre-established intervals for instant access by key personnel of the client, particularly senior executives.

The foregoing description of the preferred embodiment of the invention is to be considered as illustrative and not as limiting. Various changes and modifications will occur to those skilled in the art for performing substantially the same function, in substantially the same way, to achieve substantially the same result without departing from the true scope of the invention as defined in the appended claims.

What is claimed is

1. A method for producing custom tailored information for a client, including, but not limited to data based on client-generated information, comprising the steps of:
gathering transaction information from a client;
processing the transaction information to create reports based on the transaction information;
obtaining client-designated other information from available non-client sources;
supplying the reports based on the transaction information and the client-designated other information to a system server for storage at a specified address for the client; and
allowing client access to the stored information at the specified address for the client.

2. The method according to claim 1 wherein the reports based on the transaction information are produced at first predetermined time intervals and the client-designated other information is obtained at second predetermined time intervals.

3. The method according to claim 2 wherein at least the steps of processing the transaction information from the client, obtaining client-designated other information from available non-client sources, and supplying reports based on the transaction information and the client-designated other information to a system server all are effected by a single entity.

4. The method according to claim 3 wherein the step of allowing client access to the stored information at the specified address in the system server comprises supplying the stored information to a client terminal via a secure communications link.

5. The method according to claim 4 wherein the secure communications link is an encrypted link over a worldwide computer network.

6. The method according to claim 5 wherein the specified address for the client comprises web pages specifically configured for the client.

7. The method according to claim 6 wherein at least some of the transaction information gathered from a client comprises financial and accounting information.

8. The method according to claim 7 wherein the step of allowing client access to the stored information at the specified address is effected in response to a client-initiated request.

9. The method according to claim 8 further including the step of providing two way communication between the client and an account manager associated with the system server.

10. The method according to claim 1 wherein at least some of the transaction information gathered from a client comprises financial and accounting information.

11. The method according to claim 10 wherein the specified address for the client comprises web pages specifically configured for the client.

12. The method according to claim 1 wherein at least the steps of processing the transaction information from the client, obtaining client-designated other information from available non-client sources, and supplying reports based on the transaction information and the client-designated other information to a system server all are effected by a single entity.

13. The method according to claim 1 wherein the step of allowing client access to the stored information at the specified address is effected in response to a client-initiated request.

14. The method according to claim 1 further including the step of providing two way communication between the client and an account manager associated with the system server.

15. The method according to claim 1 wherein the step of allowing client access to the stored information at the specified address in the system server comprises supplying the stored information to a client terminal via a secure communications link.

16. The method according to claim 15 wherein the secure communications link is an encrypted link over a worldwide computer network.

17. A method for producing custom tailored information for a client including the steps of:
obtaining client-designated information from available sources at predetermined time intervals;
supplying the client-designated information obtained from available sources to a system server for storage at a specified address for the client; and
allowing client access to the stored information at the specified address.

18. The method according to claim 17 wherein the step of allowing client access to the stored information comprises continuously allowing client access to the stored information.

19. The method according to claim 18 wherein the client designated information supplied to the system server at the specified address is replaced at each of the predetermined time intervals the client designated information is obtained and supplied to the system server.

20. The method according to claim 19 wherein the step of allowing client access to the stored information at the specified address in the system server is provided in response to a predetermined password from the client.

21. The method according to claim 20 further including the step of providing two way communication between the client and an account manager associated with the system server.

22. The method according to claim 21 further including the step of obtaining transaction information from the client; and generating reports based on the transaction information from the client for subsequent access by the client at the specified address in the system server.

23. The method according to claim 17 wherein the client designated information supplied to the system server at the specified address is replaced at each of the predetermined time intervals the client designated information is obtained and supplied to the system server.

24. The method according to claim 17 wherein the step of allowing client access to the stored information at the specified address in the system server is provided in response to a predetermined password from the client.

25. The method according to claim 17 further including the step of obtaining transaction information from the client; and generating reports based on the transaction information from the client for subsequent access by the client at the specified address in the system server.

26. The method according to claim 17 further including the step of providing two way communication between the client and an account manager associated with the system server.
